(19) United States
(12) Patent Application Publication
(10) Pub. No.: US 2016/0323365 A1
(43) Pub. Date: Nov. 3, 2016

(54) CONTENT DELIVERY METHOD, APPARATUS, AND SYSTEM

(71) Applicant: Huawei Technologies Co., Ltd., Shenzhen (CN)

(72) Inventor: Wenfu Wu, Shanghai (CN)

(21) Appl. No.: 15/205,846

(22) Filed: Jul. 8, 2016

Related U.S. Application Data
(63) Continuation of application No. PCT/CN2014/070277, filed on Jan. 8, 2014.

(51) Int. Cl. H04L 29/08; H04L 12/24; H04L 29/12

(52) U.S. Cl. CPC H04L 67/10; H04L 67/18; H04L 67/2814; H04L 67/2842; H04L 61/1511; H04L 41/12

(57) ABSTRACT

Embodiments of the present invention disclose a content delivery method, including: when a content request of user equipment UE is received, acquiring location information of access of the UE; acquiring at least one content control apparatus and information about a first area that can be served by the at least one content control apparatus; determining, according to the location information and the information about the first area, a content control apparatus for serving the UE; sending a request for searching for a cache device to the determined content control apparatus, where the cache device is configured to provide content requested by the UE; receiving an identifier of a cache device returned by the content control apparatus; and sending a redirection message to the UE, so that the UE redirects to the cache device corresponding to the identifier to acquire the requested content.

### CROSS-REFERENCE TO RELATED APPLICATIONS

This application is a continuation of International Patent Application No. PCT/CN2014/070277, filed on Jan. 8, 2014, which is hereby incorporated by reference in its entirety.

### TECHNICAL FIELD

The present invention relates to the field of communications technologies, and in particular, to a content delivery method, apparatus, and system.

### BACKGROUND

A content delivery network (CDN) is a new type of network content service system, is constructed based on an IP network, and provides content delivery and a service based on an efficiency requirement, a quality requirement of content access and application. A content delivery network interconnection (CDNI) mechanism is a layered CDN mechanism and is classified into an upstream CDN and a downstream CDN, where the upstream CDN belongs to a CDN provider, and the downstream CDN generally belongs to an NSP (Network Service Provider, network service provider, which is generally a mobile network operator). A content provider/service provider (CP/SP) signs a business protocol with the upstream CDN, and the upstream CDN signs a business protocol with the downstream CDN. Daring content delivery, the upstream CDN redirects an access request of a user to the downstream CDN, and the downstream CDN delivers content to User Equipment (UE), thereby implementing shortest-path delivery of content.

An existing CDNI mechanism has the following problems: An upstream CDN may sign business protocols with multiple downstream CDNs. In this scenario, after the upstream CDN receives a content request of a user, the upstream CDN cannot determine to select which downstream CDN to serve the user, which causes a possibility that an incorrect downstream CDN is selected, where the downstream CDN does not belong to an NSP accessed by the user, and therefore cannot serve the user. Consequently, a content service requested by the user cannot be provided and user experience is extremely poor. Alternatively, a selected downstream CDN is relatively far from UE, which causes a long transmission delay, low delivery efficiency, low quality of service (QoS), and poor user experience.

### SUMMARY

Embodiments of the present invention provide a content delivery method, apparatus, and system. A cache device may be selected according to an access location of UE, which reduces network transmission bandwidth, shortens a transmission delay, thereby improving user experience. In addition, the cache device is selected according to the access location of the UE, and in this way, the selected cache device belongs to an NSP accessed by a user, so that the selected cache device can provide a content service requested by the user. In addition, a CP/SP controls whether to select a cache device of the NSP to serve the UE, thereby implementing layered control for a CUE. In addition, cache resources of the NSP can be open to the content provider or the service provider, thereby implementing monetization processing of the cache resources and increasing income of the network service provider.

To resolve the foregoing technical problem, a first aspect of the present invention provides a content delivery method, including:

when a content request of user equipment UE is received, acquiring location information of access of the UE;

determining, according to the location information, a content control apparatus for serving the UE;

sending a request for searching for a cache device to the determined content control apparatus;

receiving an identifier of a cache device returned by the content control apparatus; and

sending a redirection message to the UE, so that the UE redirects to the cache device corresponding to the identifier to acquire requested content.

Based on the first aspect, in a first possible implementation manner of the first aspect, that the content request of the user equipment UE is received includes:

receiving a content request of the user equipment UE forwarded by a content provider CP or a service provider SP, where the content request carries an identifier information of the content requested by the UE.

Based on the first aspect or the first possible implementation manner of the first aspect, in a second possible implementation manner of the first aspect, the acquiring location information of access of the UE includes:

invoking an application programming interface API provided by an open platform to acquire the location information of access of the UE; or

invoking an application programming interface API provided by the UE to acquire the location information of access of the UE.

Based on the first aspect, in a third possible implementation manner of the first aspect, the determining, according to the location information, a content control apparatus for serving the UE includes:

querying prestored registration information of at least one content control apparatus, where the registration information includes identifier information of the content control apparatus and information about an area that can be served by the content control apparatus; and

selecting one content control apparatus from the at least one content control apparatus according to the location information and the information about the area, determining the content control apparatus as the content control apparatus for serving the UE, and acquiring identifier information of the determined content control apparatus.

Based on the first aspect, in a fourth possible implementation manner of the first aspect, the determining, according to the location information, a content control apparatus for serving the UE includes:

sending a request for querying a content control apparatus to a domain name server DNS server or an application layer traffic optimization server ALTO server, where the query request carries the location information of access of the UE, the DNS server or the ALTO server prestores registration information of at least one content control apparatus, and the registration information includes identifier information of the content control apparatus and information about an area that can be served by the content control apparatus; and

acquiring identifier information of one content control apparatus selected from the at least one content control apparatus by the DNS server or the ALTO server according to the location information and the information about the area, where the content control apparatus is determined as the content control apparatus for serving the UE.

Based on the third possible implementation manner of the first aspect or the fourth possible implementation manner of the first aspect, in a fifth possible implementation manner of the first aspect, the sending a request for searching for a cache device to the determined content control apparatus includes:

sending the request for searching for a cache device to the content control apparatus according to address information of the content control apparatus.

A second aspect of the present invention provides a content delivery method, including:

receiving a request for searching for a cache device of a content delivery apparatus;

acquiring location information of access of the UE;

determining a cache device for the UE according to the location information; and

sending an identifier corresponding to the determined cache device to the content delivery apparatus, so that the content delivery apparatus sends a redirection message to the UE, and the UE redirects to the cache device corresponding to the identifier to acquire requested content.

Based on the second aspect, in a first possible Implementation manner of the second aspect, the search request carries the location information of access of the user equipment UE; and

the acquiring location information of access of the UE includes:

parsing the search request to acquire the location information of access of the user equipment UE.

Based on the second aspect, in a second possible implementation manner of the second aspect, the acquiring location information of access of the UE includes:

invoking an application programming interface API provided, by an open platform to acquire the location information of access of the UE; or

invoking an application programming interface. API provided by the UE to acquire the location information of access of the UE.

Based on the second aspect, the first possible implementation, manner of the second aspect, or the second possible implementation, manner of the second aspect, in a third possible implementation manner of the second aspect, before the receiving a request for searching for a cache device of a content delivery apparatus, the method further includes:

sending registration information to the content delivery apparatus, where the registration information includes identifier information of a content control apparatus and information about an area that can be served by the content control apparatus; or

sending registration information to a domain name server DNS server or an application layer traffic optimization server ALTO server, where the registration information includes identifier information of a content control apparatus and information about an area that can be served by the content control apparatus.

Based on the third possible implementation manner of the second aspect, in a fourth possible implementation manner of the second aspect, the determining a cache device for the UE according to the location information includes:

acquiring identifier information of cache devices of all network elements of a network service provider NSP;

determining, according to the location information and the identifier information of the cache devices, a first, cache device as the cache device that provides the content requested by the UE.

Based on the fourth possible implementation manner of the second aspect, in a fifth possible implementation manner of the second aspect, the determining a cache device for the UE further includes:

delivering instruction information to the determined cache device, where the instruction information is used to instruct the cache device to store the requested content or submit the requested content to the UE when a content request of the UE is received.

A third aspect of the present invention provides a content delivery apparatus, including:

a first location information acquiring module, configured to: when a content request of user equipment UE is received, acquire location information of access of the UE;

a content control apparatus determining module, configured to determine, according to the location information, a content control apparatus for serving the UE;

a search request sending module, configured to send a request for searching for a cache device to the determined content control apparatus;

an identifier receiving module, configured to receive an identifier of a cache device returned by the content control apparatus; and

a message sending module, configured to send a redirection message to the UE, so that the UE redirects to the cache device corresponding to the identifier to acquire requested content.

Based on the third aspect, in a first possible implementation manner of the third aspect, the apparatus further includes:

a content request receiving module, configured to receive a content request of the user equipment UE forwarded by a content provider CP or a service provider SP, where the content request carries an identifier information of the content requested by the UE.

Based on the third aspect or the first possible implementation manner of the third aspect, in a second possible implementation manner of the third aspect, the first location information acquiring module includes:

a first invoicing unit, configured to invoke an application programming interface API provided by an open platform to acquire the location information of access of the UE; or

a second invoking unit, configured to invoke an application programming interface API provided by the UE to acquire the location information of access of the UE.

Based on the third aspect, in a third possible implementation manner of the third aspect, the content control apparatus determining module includes:

a first registration information querying unit, configured to query prestored registration information of at least one content control apparatus, where the registration information includes identifier information of the content control apparatus and information about an area that can be served by the content control apparatus; and

a first address information acquiring unit, configured to select one content control apparatus from the at least one content control apparatus according to the location information and the information about the area, determine the content control apparatus as the content control apparatus for serving the UE, and acquire identifier information of the content control apparatus.

Based on the third aspect, in a fourth possible implementation manner of the third aspect, the content control apparatus determining module includes:

a second registration information querying unit, configured to send a request for querying a content control apparatus to a domain name server DNS server or an application layer traffic optimization server ALTO server, where the query request carries the location information of access of the UE, the DNS server or the ALTO server restores registration information of at least one content control apparatus, and the registration information includes identifier information of the content control apparatus and information about an area that can be served by the content control apparatus; and

a second address information acquiring unit, configured to acquire identifier information of one content control apparatus selected from the at least one content control apparatus by the DNS server or the ALTO server according to the location information and the information about the area, where the content control apparatus is determined as the content control apparatus for serving the UE.

Based on the third possible implementation manner of the third aspect or the fourth possible implementation manner of the third aspect, in a fifth possible implementation manner of the third aspect, the search request sending module includes:

a search request sending unit, configured to send the request for searching for a cache device to the content control apparatus according to the identifier information of the content control apparatus.

A fourth aspect of the present invention provides a content control apparatus, including:

a search request receiving module, configured to receive a request for searching for a cache device of a content delivery apparatus;

a second location information acquiring module, configured, to acquire location information of access of UE;

a cache device determining module, configured to determine a cache device for the UE according to the location information; and

an identifier sending module, configured to send an identifier corresponding to the determined cache, device to the content delivery apparatus, so that the content delivery apparatus sends a redirection message to the UE, and the UE redirects to the cache device corresponding to the identifier to acquire requested content.

Based on the fourth aspect, in a first possible implementation manner of the fourth aspect, the search request carries the location information of access of the user equipment UE; and the second location information acquiring module includes:

a location information acquiring unit, configured to parse the search request to acquire the location information of access of the user equipment UE.

Based on the fourth aspect, in a second possible implementation manner of the fourth aspect, the second location information acquiring module includes:

a third invoking unit, configured to Invoke an application programming interface API provided by an open platform to acquire the location information of access of the UE; or

a fourth invoking unit, configured to invoke an application programming interface API provided by the UE to acquire the location information of access of the UE.

Based on the fourth aspect, the first possible implementation manner of the fourth aspect, or the second possible implementation manner of the fourth aspect, in a third possible implementation manner of the. fourth aspect, the apparatus further includes:

a first registration information sending module, configured to send registration information to the content delivery apparatus, where the registration information includes identifier information of the content control apparatus and information about an area that can be served by the content control apparatus; or

a second registration information sending module, configured to send registration information to a domain name server DMS server or an application layer traffic optimization server ALTO server, where the registration information includes identifier information of the content control apparatus and information about an area that can be served by the content control apparatus.

Based on the third possible implementation manner of the fourth aspect, in a fourth possible, implementation manner of the fourth aspect, the cache device determining module includes:

a cache device information acquiring unit, configured to acquire identifier information of cache devices of all network elements of a network service provider NSP;

a cache device determining unit, configured to determine, according to the location information and the identifier information of the cache devices, a first cache device as the cache device that provides the content requested by the UE.

Based on the fourth possible implementation, manner of the fourth aspect, in a fifth possible implementation manner of the fourth aspect, the Cache device determining module further includes:

an instruction information sending unit, configured to deliver instruction information to the determined first cache device, where the instruction information is used to instruct the cache device to store the requested content or submit the requested content to the UE when a content request of the UE is received.

A fifth aspect of the present invention provides a content delivery system, including the content delivery apparatus according to the third aspect of the present invention and the content control apparatus according to the fourth aspect of the present invention.

A sixth aspect of the present invention provides a computer storage medium, where the computer storage medium stores a program, and the program performs the steps according to the first aspect of the present invention.

A seventh aspect of the present invention provides a computer storage medium, where the computer storage medium stores a program, and the program performs the steps according to the second aspect of the present invention.

An eighth aspect of the present invention provides a content delivery apparatus, including: a first processor, a first memory, a first input device, and a first output device; where

the first processor performs the following steps:

when a content request of user equipment UE is received, acquire location information of access of the UE;

determine, according to the location information, a content control apparatus for serving the UE;

control the first output device to send a request for searching for a cache device to the determined content control apparatus;

control the first input device to receive an identifier of a cache device returned by the content control apparatus; and

control the first output device to send a redirection message to the UE, so that the UE redirects to the cache device corresponding to the identifier to acquire requested content.

Based on the eighth aspect, in a first possible implementation manner of the eighth aspect, the first processor is specifically configured to includes:

control the first input, device to receive a content request of the user equipment UE forwarded by a content provider CP or a service provide. SP, where the content request carries a uniform resource locator URL address of the content requested by the UE.

Based on the eighth aspect or the first possible implementation manner of the eighth aspect, in a second possible implementation manner of the eighth aspect, that the first processor acquires the location information of access of the UE includes:

invoking an application programming interface API provided by an open platform to acquire the location information of access of the UE; or

invoking an application programming interface API provided by the UE to acquire the location information of access of the UE.

Based on the second possible implementation manner of the eighth aspect, in a third possible implementation manner of the eighth aspect, that the first processor determines, according to the location information, the content control apparatus for serving the UE includes:

querying prestored registration information of at least one content control apparatus, where the registration information includes identifier information of the content control apparatus and information about an area that can be served by the content control apparatus; and

selecting one content control apparatus from the at least one content control apparatus according to the location information and the information about the area, determining the content control apparatus as the content control apparatus for serving the UE, and acquiring identifier information of the determined content control apparatus.

Based on the second possible implementation manner of the eighth aspect, in a fourth possible implementation manner of the eighth aspect, that the first processor determines, according to the location information, the content control apparatus for serving the UE includes:

sending a request for querying a content control apparatus to a domain name server DNS server or an application layer traffic optimization server ALTO server, where the query request carries the location information of access of the UE, the DNS server or the ALTO server prestores registration information of at least one content control apparatus, and the registration information includes identifier information of the content control apparatus and information about an area that can be served by the content control apparatus; and

acquiring identifier information of one content control apparatus selected from the at least one content control apparatus by the DNS server or the ALTO server according to the location information and the information about the area, where the content control apparatus is determined as the content control apparatus for serving the UE.

Based on the third possible implementation manner of the eighth aspect or the fourth possible implementation manner of the eighth aspect, in a fifth possible implementation manner of the eighth aspect, that the first processor controls the first output device to send the request for searching for a cache device to the determined content control apparatus includes:

controlling, according to the identifier information of the content control apparatus, the first output device to send the request for searching for a cache device to the content control apparatus.

A ninth aspect of the present invention provides a content control apparatus, including: a second processor, a second memory, a second input device, and a second output device; where

the second processor performs the following steps:

control the second input device to receive a request for searching for a cache device of a content delivery apparatus, where the cache device is configured to provide content requested by user equipment UE;

acquire location information of access of the UE;

determine a cache device for the UE according to the location information; and

control the second output device to send an identifier corresponding to the determined cache device to the content delivery apparatus, so that the content delivery apparatus sends a redirection message to the UE, and the UE redirects to the cache device corresponding to the identifier to acquire the requested content.

Based on the ninth aspect, in a first possible implementation manner of the ninth aspect, the search request carries the location information of access of the user equipment UE; and

that the first processor acquires the location information of access of the UE includes:

parsing the search request to acquire the location information of access of the user equipment UE.

Based on the ninth aspect, in a second possible implementation manner of the ninth aspect, that the first processor acquires the location information of access of the UE includes;

invoking an application programming Interface API provided by an open platform to acquire the location information of access of the UE; or

invoking an application programming interface API provided by the UE to acquire the location information of access of the UE.

Based on the ninth aspect, the first possible implementation manner of the ninth aspect, or the second possible implementation manner of the ninth aspect, in a third possible implementation manner of the ninth aspect, before controlling the second, input device to receive the request for searching for a cache device of the content delivery apparatus, the second processor is further configured to:

control the second output device to send registration information to the content delivery apparatus, where the registration information includes identifier information of the content control apparatus and information about an area that can be served by the content control apparatus; or

control the second output device to send registration information to a domain name server DNS server or an application layer traffic optimization server ALTO server, where the registration information includes identifier information of the content control apparatus and information about an area that can be served by the content control apparatus.

Based on the third possible implementation manner of the ninth aspect, in a fourth possible implementation manner of the ninth aspect, that the second processor determines the cache device for the UE according to the location information includes;

acquiring identifier information of cache devices of all network, elements of a network service provider NSP;

determining, according to the location information and the identifier information of the cache devices, a first cache device as the cache device that provides the content requested by the UE.

Based on the fourth possible implementation manner of the ninth aspect, in a fifth possible implementation manner of the ninth, aspect, that the first processor determines the cache device for the UE further includes:

controlling the second output device to deliver instruction information to the determined first cache device, where the instruction information is used to instruct the cache device to store the requested content or submits the requested content to the UE when a content request of the UE is received.

The embodiments of the present invention have the following beneficial effects: A content delivery apparatus selects, according to an access location of UE, a content control apparatus to serve the UE; the selected content control apparatus reselects, for the UE, a cache device configured to provide requested content; and the UE can redirect to the cache device to acquire the requested content. Because the reselected cache device may be selected at a location close to the UE, a data interaction path between the UE and the cache device is shortened, which reduces transmission bandwidth of an operator network, thereby improving user experience. In addition, the content control apparatus for serving the UE is selected according to the access location of the UE, and in this way, the cache device selected by the selected content control apparatus belongs to an NSP accessed by a user, so that the selected cache device can provide a content service requested, by the user. In addition, the content delivery apparatus controls whether to select a cache device of the network service provider to serve the UE, that is, a CP/SP controls whether to select a cache device of the NSP to serve the UE, thereby implementing layered control for a CDN. In addition, cache resources of the network service provider can be open to the content provider or the service provider, thereby implementing monetization processing of the cache resources and increasing income of the network service provider.

### BRIEF DESCRIPTION OF THE DRAWINGS

To describe the technical solutions in the embodiments of the present invention or in the prior art more clearly, the following briefly describes the accompanying drawings required for describing the embodiments. Apparently, the accompanying drawings in the following description show merely some embodiments of the present invention, and a person of ordinary skill in the art may still derive other drawings from these accompanying drawings without creative efforts.

FIG. 1 is a schematic flowchart of a content delivery method according to an embodiment of the present invention;

FIG. 2 is a schematic interaction diagram of a content delivery method according to an embodiment of the present invention;

FIG. 3 is a schematic flowchart of another content delivery method according to an embodiment of the present invention;

FIG. 4 is a schematic structural diagram of a content delivery apparatus according to an embodiment of the present invention;

FIG. 5 is a schematic structural diagram of a first location information acquiring module according to an embodiment of the present invention;

FIG. 6 is a schematic structural diagram of another first location information acquiring module according to an embodiment of the present invention;

FIG. 7 is a schematic structural diagram of a content control apparatus acquiring module according to an embodiment of the present invention;

FIG. 8 is a schematic structural diagram of another content control apparatus acquiring module according to an embodiment of the present invention;

FIG. 9 is a schematic structural diagram of a content control apparatus determining module according to an embodiment of the present invention;

FIG. 10 is a schematic structural diagram of another content control apparatus determining module according to an embodiment of the present invention;

FIG. 11 is a schematic structural diagram of a content control apparatus according to an embodiment of the present invention;

FIG. 12 is a schematic structural diagram of a registration information sending module according to an embodiment of the present invention;

FIG. 13 is a schematic structural diagram of another registration information sending module according to an embodiment of the present invention;

FIG. 14 is a schematic structural diagram of a second location information acquiring module according to an embodiment of the present invention;

FIG. 15 is a schematic structural diagram of another second location information acquiring module according to an embodiment of the present, invention;

FIG. 16 is a schematic structural diagram of still another second location information acquiring module according to an embodiment of the present invention;

FIG. 17 is a schematic structural diagram of a cache device acquiring module according to an embodiment of the present invention;

FIG. 18 is a schematic structural diagram of a cache device determining module according to an embodiment of the present invention;

FIG. 19 is a schematic structural diagram of a first processor according to an embodiment of the present invention; and

FIG. 20 is a schematic structural diagram of a second processor according to an embodiment of the present invention.

### DETAILED DESCRIPTION

The following clearly and describes the technical solutions in the embodiments of the present invention with reference to the accompanying drawings in the embodiments of the present invention. Apparently, the described embodiments are merely some but not all of the embodiments of the present invention. Ail other embodiments obtained by a person of ordinary skill in the art based on the embodiments of the present invention without creative efforts shall fall within the protection scope of the present invention.

The following provides detailed descriptions separately by using specific embodiments.

In the embodiments of the present invention, a content delivery apparatus and a content control apparatus (that is, a content control apparatus) may be independent network elements, or may be built into another network element. For example, a function of the content control apparatus may be implemented in a gateway of a mobile network. An interface between network elements may be a message interface or an application programming interface Application Programming Interface (API).

The content delivery apparatus and the content control apparatus may be a software-defined networking Software-Defined Networking (SDN) controller, a CDN controller, a domain name system Domain Name System (DNS) controller, or the like, which is not limited in this embodiment of the present invention.

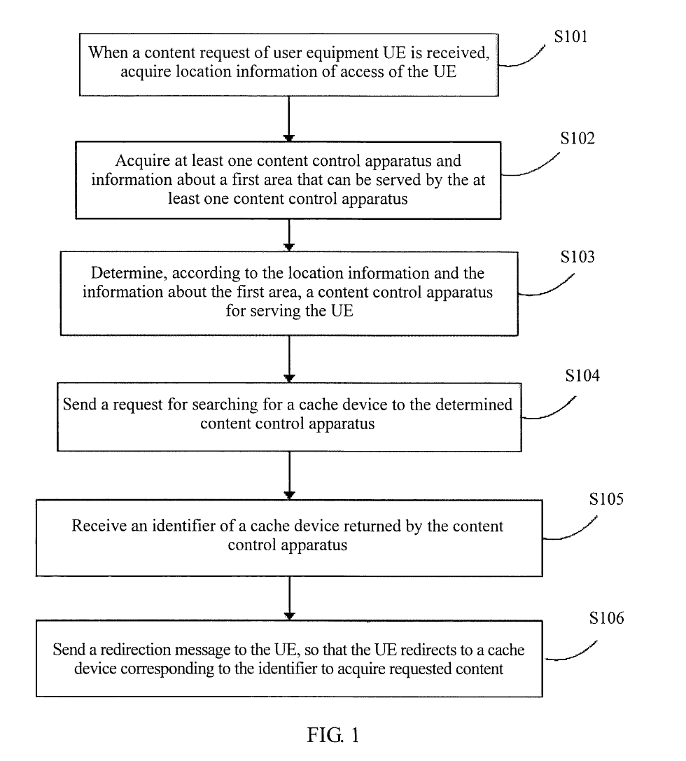

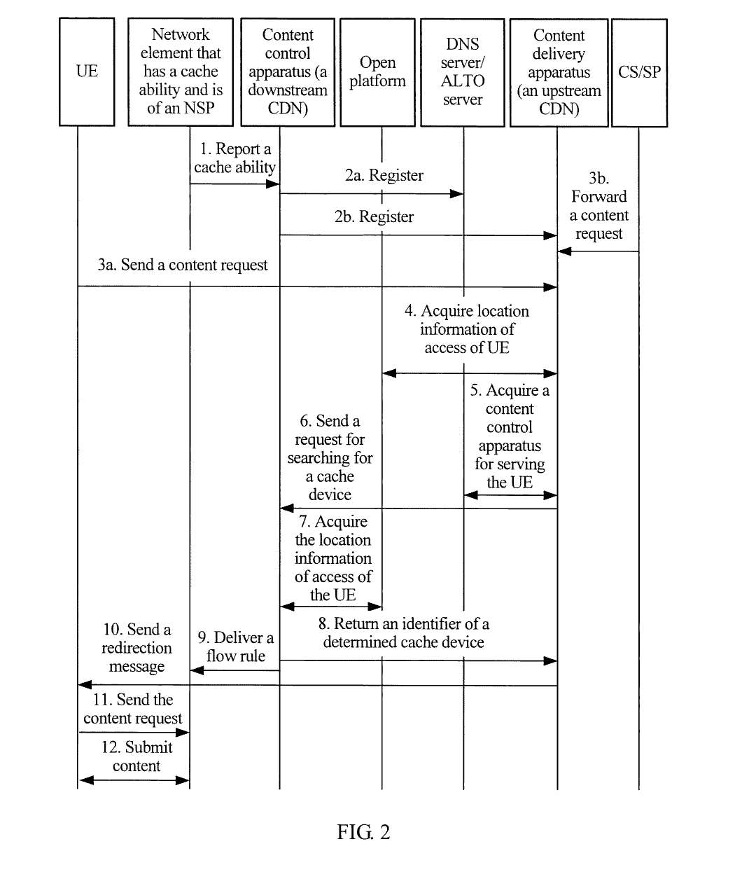

Referring to FIG. 1 and FIG. 2 together, which are respectively a schematic flowchart and a schematic interaction diagram of a content delivery method according to an embodiment of the present invention, this embodiment provides descriptions on a perspective of a content delivery apparatus (that is, an upstream CDN) of a content delivery network CDN provider, and the method includes steps S101 to S106.

S101. When a content request of user equipment; UE is received, acquire location information of access of the UE.

In some embodiments of the present invention, a specific implementation manner of receiving the content request of the user equipment UE includes: directly receiving a content request from the UE, or receiving a content request of the UE forwarded by a content provider (CP) or a service provider (SP). The content request carries an identifier (for example, a uniform resource locator (URL) or a uniform resource identifier (URI) of content requested by the UE. The identifier of the requested content indicates a location and an access method of a resource that can be obtained from the Internet, and is an address of a standard resource on the Internet. Each file on the Internet has a unique identifier, and information included in the unique identifier indicates a location of content requested by the UE and a method of processing the requested content by a browser of the UE.

The CP or the SP refers to a service provider that provides a large quantity of rich and practical information on the Internet. A product provided by the CP or the SP is a network content service, which includes a search engine, a virtual community, an email box, news and entertainment, and the like. The content provider or the service provider may allow access to a server of the service provider in various manners such as private line access and dial-up access, and provide various information services. After acquiring the content request of the UE, the CP or the SP forwards the content request to the content delivery apparatus, and the content delivery apparatus selects a cache device for serving the UE.

In some embodiments of the present invention, a specific implementation manner of acquiring the location information of access of the. UE includes: invoking an application programming interface API provided by an open platform to acquire the location information of access of the UE, or invoking an API provided by the UE to acquire the location information of access of the UE. The API is some predefined functions, and a purpose is to provide, for an application program and a developer, an ability to access a routine based on software or hardware without accessing source code or understanding details of an internal working mechanism.

The location information of access of the UE includes a routing area (RA), a location area (LA), a tracking area (TA), a cell (Cell), or the like.

S102. Acquire at least one content control apparatus and information about a first area that can be served by the at least one content control apparatus, which specifically includes:

querying stored registration information of the at least one content control apparatus according to the location information, where the registration information includes identifier information of the content control apparatus and the information about the first area that can be served by the content control apparatus; or

sending a request for querying a content control apparatus to a domain name server DNS server or an application layer traffic optimization server ALTO server, where the query request carries the location information of access of the UE, so that the DNS server or the ALTO server queries stored registration information of the at least; one content control apparatus according to the location information, and the registration information includes identifier information of the content control apparatus and the information about the first area that can be served by the content control apparatus.

That is, the content control apparatus may submit a registration request to the content delivery apparatus, the DNS server, or the ALTO server, where the registration request includes the information about the first area that can be served by the content control apparatus. The content delivery apparatus, the DNS server, or the ALTO server configures, according to the submitted request, the identifier information of the corresponding content control apparatus and the information about the first area that can be served by the corresponding content control apparatus.

In another implementation manner, the content control apparatus may register with another control system such as an operation support system (OSS) or a business support system (BSS) of an NSP. Similarly, registration information includes identifier information of the content control apparatus and information about an area that can be served by the content control apparatus. When the registration information of the content control apparatus needs to be acquired, the content delivery apparatus, the DNS server, or the ALTO server may send a query request to the OSS or the BSS, where the query request also carries the location information of access of the UE. The OSS or the BSS queries the stored registration information of the at least one content control apparatus according to the location information and returns the stored registration information to the content delivery apparatus, the DNS server, or the ALTO server.

It should be noted that the content control apparatus has a control logic function provided by the network service provider (NSF), that is, a mobile network operator, and is mainly configured to search for and select a cache device. The identifier information of the content control apparatus includes address information (an IP address or a URL address) of the content control apparatus, a fully qualified domain name FQDN (Fully Qualified Domain Name), or the like. The information about the first area that can be served by the content control apparatus includes a routing area (RA), a location area (LA), a tracking area (TA), a cell (cell) or the like that can be served by the content control apparatus.

S103. Determine, according to the location information and the information about the first area, a content control apparatus for serving the UE.

Specifically, in an implementation manner, the content delivery apparatus selects one content control apparatus from the at least one content control apparatus according to the location information and the information about the first area, and determines the content control apparatus as the content control apparatus for serving the UE, which may be specifically: selecting a content control apparatus whose service area is closest to the UE as the content control apparatus for serving the UE, that is, information about a first area that can be served by the selected content control apparatus includes the location information of access of the UE. Further, identifier information of the determined content control apparatus is acquired.

In another implementation manner, the content delivery apparatus receives the registration information of the at least one content control apparatus returned by the DNS server or the ALTO server, selects one content control apparatus from the at least one content control apparatus according to the location information and the information about the first area, and determines the content control apparatus as the content control apparatus for serving the UE. Further, receiving identifier information of the determined content control apparatus is included.

S104. Send a request for searching for a cache device to the determined content control apparatus.

It should be noted that the request for searching for a cache device is sent to the content control apparatus according to the identifier information of the content control apparatus, where the search request may carry identifier information of the content requested by the UE. In an implementation manner, the search request further carries the location information of access of the UE. The content control apparatus stores a correspondence between an identifier of a cache device and information about an area that can be served by the cache device. The content control apparatus can select, according to the location, information of access of the UE and the correspondence, a cache device as a cache device that provides the requested content. Specifically, the content control apparatus may determine, according to the location information and the correspondence, a cache device closest to the UE as the cache device that provides the requested content for the UE, and deliver a flow rule to the determined cache device, where the flow rule carries the identifier information of the content requested by the UE, and the identifier is used to instruct the determined cache device to cache or submit the requested content when a content request that is of the UE and that is corresponding to the identifier is received.

In an implementation manner, if the content control apparatus determines multiple cache devices according to the location information of access of the UE, that is, information about areas that can be served by the multiple cache devices includes the location information of access of the UE. Further, it is queried whether the content corresponding to the identifier information of the content requested by the UE is cached in these cache devices. If the content is cached in these cache devices, a cache device that caches the content requested by the UE is selected as a cache device that provides the requested content,

S105. Receive an identifier of a cache device returned by the content control apparatus.

Specifically, an identifier of the cache device determined by the content control apparatus according to the location information of access of the UE is received.

S106. Send a redirection message to the UE, so that the UE redirects to the cache device corresponding to the identifier to acquire requested content.

Specifically, the redirection message HTTP Redirect includes the identifier of the determined cache device. After receiving the redirection message, the UE re-sends a content request to the cache device according to identifier information of the cache device. The cache device acquires content according to an identifier that is of the requested content and carried in the content request, and sends the content to the UE. In this case, content submitting processing is completed.

In this embodiment of the present invention, a content delivery apparatus selects, according to an access location of UE, a content control apparatus to serve the UE; the selected content control apparatus reselects, for the UE, a cache device configured to provide requested content; and the UE can redirect to the cache device to acquire the requested content. Because the reselected cache device may be selected at a location close to the UE, a data interaction path between the UE and the cache device is shortened, which reduces transmission bandwidth of an operator network, shortens a transmission delay, thereby improving user experience. In addition, the content control apparatus for serving the UE is selected according to the access location of the UE, and in this way, the cache device selected by the selected content control apparatus belongs to an NSP accessed by a user, so that the selected cache device can provide a content service requested by the user. In addition, the content delivery apparatus controls whether to select a cache device of the network service provider to serve the UE, that is, a CP/SP controls whether to select a cache device of the NSP to serve the UE, thereby implementing layered control for a CDN. In addition, cache resources of the network, service provider can be open to the content provider or the service provider, thereby implementing monetization processing of the cache resources and increasing income of the network service provider.

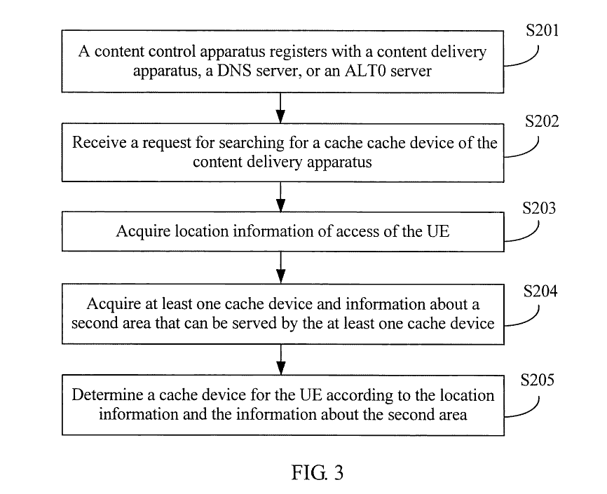

Referring to FIG. 2 and FIG. 3 together, which are respectively a schematic flowchart and a schematic interaction diagram of a content delivery method according to an embodiment of the present invention, this embodiment provides descriptions on a perspective of a content control apparatus (that is, a downstream CON) of a network service provider NSP, and the method mainly includes steps S201 to S205.

S201. The content control apparatus registers with a content delivery apparatus, a domain name server DNS server, or an application layer traffic optimization server ALTO server, which specifically includes:

sending registration information to the content delivery apparatus, where the registration information includes identifier information of the content control apparatus and information about a first area that can be served by the content control apparatus, so that the content delivery apparatus determines, according to location information of access of user equipment UE and the information about the first area, a content control apparatus for serving the UE; or

sending registration information to a domain name server DNS server or an application layer traffic optimization server ALTO server, where the registration information includes identifier information of the content control apparatus and information about a first area that can be served by the content control apparatus, so that the DNS server or the ALTO server determines, according to location information of access of user equipment UE and the information about the first area, a content control apparatus for serving the UE.

That is, the content control apparatus may submit a registration request to the content delivery apparatus, the DNS server, or the ALTO server, where the registration request includes the information about the first area that can be served by the content control apparatus. The content delivery apparatus, the DNS server, or the ALTO server configures, according to the submitted request, the identifier information of the corresponding content control apparatus and the information about the first area that can be served by the corresponding content control apparatus.

In another implementation manner, the content control apparatus may register with another control system such as an operation support system (OSS) or a business support system (BSS) of an NSP. Similarly, registration information includes identifier information of the content control apparatus and information about an area that can be served by the content control apparatus.

It should be noted that the content control apparatus has a control logic function provided by the network service provider NSP (Network Service Provider), that is, a mobile network operator, and is mainly configured to search for and select a cache device. The identifier information of the content control apparatus includes address information (an IP address or a URL address) of the content control apparatus, a fully qualified domain, name (FQDN), or the like. The information about the first area that can be served by the content control apparatus includes a routing area (RA), a location area (LA), a tracking area (TA), a cell (cell), or the like that can be served by the content control apparatus.

S202. Receive a request for searching for a cache device of the content delivery apparatus, where the cache device is configured to provide content requested by user equipment UE, and the search request may carry an identifier information of the content requested by the UE.

In some implementation manners of the present invention, if the content control, apparatus registers with the content delivery apparatus, the content; delivery apparatus may acquire the identifier information of the content control apparatus according to the registration information and send the search request to the content control apparatus.

In some implementation manners of the present invention, if the content control apparatus registers with the domain name server DNS server or the application layer traffic optimization server ALTO server, after acquiring an identifier information of the content control apparatus from the DNS server or the ALTO server according to the location information of access of the UE, the content delivery apparatus sends the search request to the content control apparatus.

In some implementation manners of the present invention, if the content control apparatus registers with the OSS or the BSS, after acquiring the registration information of the content control apparatus from the OSS or the BSS, the content delivery apparatus sends the search request to the content control apparatus; or the DNS server or the ALTO server acquires the registration information of the content control apparatus from the OSS or the BSS, and after the content, delivery apparatus, acquires an identifier information of the content control apparatus from the DNS server or the ALTO server according to the location information of access of the UE, the content delivery apparatus sends the search request to the content, control apparatus.

S203. Acquire location information of access of the UE.

In some embodiments of the present invention, if the search request carries the location information of access of the UE, that is, the content delivery apparatus directly provides the location information of access of the UE for the content control apparatus, the content, control apparatus may directly acquire, by parsing the search request, the location information of access of the user equipment UE.

In some embodiments of the present invention, if the search request does not carry the location information of access of the user equipment UE, the content control apparatus may acquire a location information accessed by the UE in the following two implementation manners:

One of the two manners is invoking an application programming interface API provided by an open platform to acquire the location information of access of the UE; the other of the two manners is invoking an application programming interface API provided by the UE to acquire the location information of access of the UE. The API is some predefined functions, and a purpose is to provide, for an application program and a developer, an ability to access a routine based on software or hardware without accessing source code or understanding details of an internal working mechanism.

S204. Acquire at least one cache device and information about a second, area that can be served by the at least one cache device.

Specifically, at least one cache device of a network element of the network service provider NSP and information about a second area that can be served by the at least one cache device are acquired. It should be noted that the content control apparatus needs to acquire in advance and store a cache ability of each network element of the NSP, that is, information about a cache device that has a cache ability of a network element, such as an access network element (for example, a radio network controller RNC (Radio Network Controller), a base station controller BSC (Base Station Controller), or an E-UTRAN NodeB eNodeB (E-UTRAN NodeB)), a gateway (for example, a gateway GPRS support node (GGSN) or a packet data network gateway (PDN GW), or a CDN, is sent to the content control apparatus.

The information about the second area that can be served by the at least one cache device, includes a routing area (RA), a location area (LA), a tracking area (TA), a cell (Cell), or the like that can he served by the cache device.

S205. Determine a cache device for the UE according to the location information and the information about the second area.

Specifically, a cache devices is selected, from the at least one cache device according to the location information and the information about the second area that can be served by the at least one cache device, as the cache device that provides the content requested by the UE.

It should be noted that cache devices of all network elements of the NSP may include a cache device of an access network, a cache device of a gateway, a cache device of a CDN, or the like, and each cache device has a cache ability to an extent. After acquiring cache ability information of a cache device, the content control apparatus selects, according to the location information of access of the UE and a correspondence between identifier information of a cache device and information about an area that can be served by the cache device, a cache device closest to the UE as the cache device for serving the UE, that is, the information about the second area that can be served by the cache device includes the location information of access of the UE.

In this embodiment of the present invention, if at least two cache devices are selected, it is queried whether the content corresponding to the identifier information of the content requested by the UE is already cached in the selected cache devices. If one of the cache devices caches the content, the cache device that caches the content requested by the UE is selected as the cache device that provides the content requested by the UE. If none of the at least two selected cache devices caches the content, a cache device closest to the UE is selected according to the location information as the cache device that provides the content requested by the UE.

Further, the content control apparatus further delivers instruction information to the determined cache device, where the instruction information carries the identifier information of the content requested by the UE, and the instruction information is used to instruct the determined cache device to store the requested content or submit the requested content to the UE when a content, request of the UE is received. After receiving the instruction information, if receiving the content, request of the UE, the determined cache device accesses a corresponding site according to the identifier that: is of the requested content and carried in the content request, and acquires and stores the requested content. Alternatively, if it is queried, according to the identifier that is of the requested content and carried in the content request, that the cache device has corresponding cache content, the cache content is submitted to the

S206. Send an identifier corresponding to the determined cache device to the content delivery apparatus, so that, the content delivery apparatus sends a redirection message to the UE, and the UE redirects to the cache device corresponding to the identifier to acquire the requested content.

It should be noted that the identifier corresponding to the determined cache device includes URL information or URI information of the cache device. After the content delivery apparatus receives the URL information or the URI information of the cache device, the redirection message HTTP Redirect sent to the UE includes the URL information or the URI information of the cache device. The cache device acquires the content requested by the UE from a content provider CP or a service provider SP and stores the content requested by the UE. The UE may redirect to a cache device corresponding to the URL information or the URI information according to the URL information or the URI information of the cache device in the redirection message. In this case, content submitting processing is completed.

In this embodiment of the present invention, a content delivery apparatus selects, according to an access location of UE, a content control apparatus to serve the UE; the selected content control apparatus reselects, for the UE, a cache device configured to provide requested content; and the UE can redirect to the cache device to acquire the requested, content. Because the reselected cache device maybe selected at a location close to the UE, a data interaction path between the UE and the cache device is shortened, which reduces transmission bandwidth of an operator network, shortens a transmission delay, thereby improving user experience. In addition, the content control apparatus for serving the UE is selected according to the access location of the UE, and in this way, the cache device selected by the selected content control apparatus belongs to an NSP accessed by a user, so that the selected cache device can provide a content service requested by the user. In addition, the content delivery apparatus controls whether to select a cache device of the network service provider to serve the UE, that is, a CP/SP controls whether to select a cache device of the NSP to serve the UE, thereby implementing layered control for a CDN. In addition, cache resources of the network service provider can be open to the content provider or the service provider, thereby implementing monetization processing of the cache resources and increasing income of the network service provider.

For better implementation of the foregoing solutions in the embodiments of the present invention, the following further provides related apparatuses cooperated to implement the foregoing solutions.

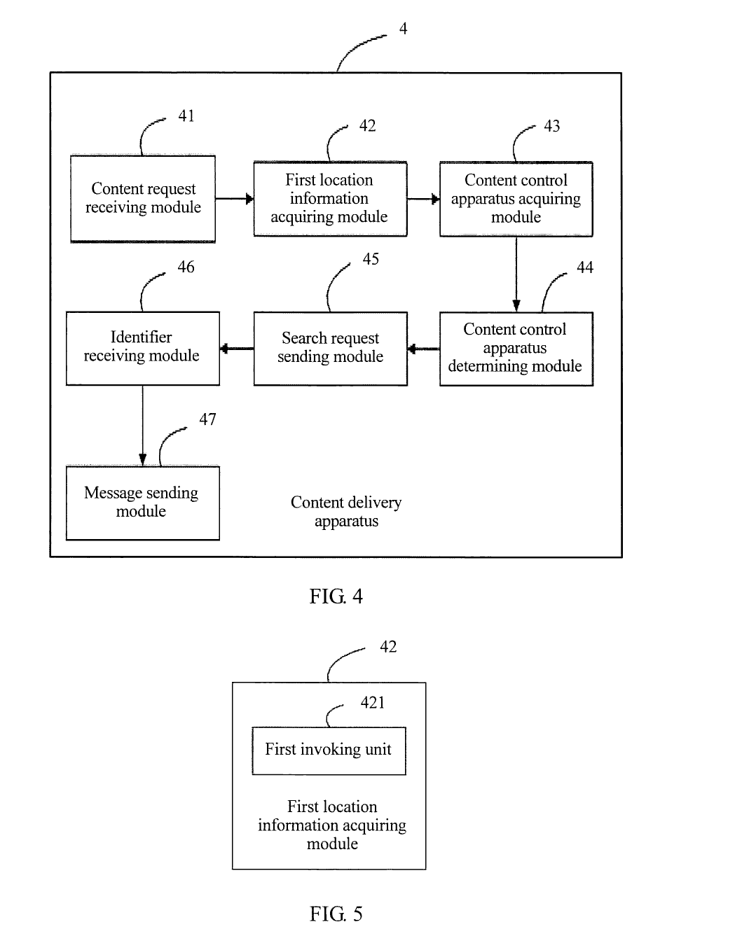

Referring to FIG. 4. FIG. 4 is a schematic structural diagram of a content delivery apparatus according to an embodiment of the present invention. A content delivery apparatus 4 (that is, an upstream CDN) is provided by a CDN provider, and the content delivery apparatus 4 includes a content request receiving module 41, a first, location information acquiring module 42, a content control apparatus acquiring module 43, a content control apparatus determining module 44, a search request sending module 45, an identifier receiving module 46, and a message sending module 47. Working processes of all the modules are separately as follows:

The content request receiving module 41 is configured to receive a content request of user equipment us forwarded by a content provider CP or a service provider SP, where the content request carries an identifier of content requested by the UE. Certainly, in another embodiment of the present invention, the content request receiving module 41 may alternatively be configured to directly receive a content request from UE.

The content request carries the identifier (for example, a uniform resource locator (URI) or a uniform resource identifier (URI) of the content requested by the UE. The identifier of the requested content indicates a location and an access method of a resource that can be obtained from the Internet, and is an address of a standard resource on the Internet. Each file on the Internet has a unique identifier, and information included in the unique identifier indicates a location of content requested by the UE and a method of processing the requested content by a browser of the UE.

The CP or the SP refers to a service provider that provides a large Quantity of rich and practical information on the Internet. A product provided by the CP or the SP is a network content service, which includes a search engine, a virtual community, an email box, news and entertainment, and the like. The content, provider or the service provider may allow access to a server of the service provider in various manners such as private line access and dial-up access, and provide various information services. After acquiring the content request of the UE, the CP or the SP forwards the content request to the content delivery apparatus 4, and the content delivery apparatus selects a cache device for serving the UE.

The first location information acquiring module 42 is configured to: when the content request of the user equipment UE is received, acquire location information of access of the UE.

Referring to FIG. 5, in some embodiments of the present invention, the first location information acquiring module 42 includes a first invoking unit 421. The first invoking unit 421 is configured to invoke an application programming interface API provided by an open platform to acquire the location information of access of the UE.

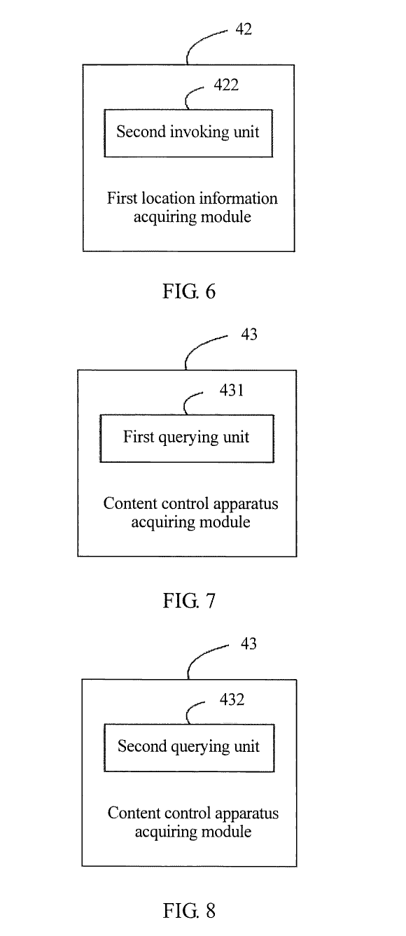

Referring to FIG. 6, in some embodiments of the present invention, the first location information acquiring module 42 includes a second invoking unit 422. The second invoking unit 422 is configured to invoke an application programming interface API provided by the UE to acquire the location information of access of the UE.

The API is some predefined functions, and a purpose is to provide, for an application program and a developer, an ability to access a routine based on software or hardware without accessing source code or understanding details of an internal working mechanism.

The content control apparatus acquiring module 43 is configured to acquire at least one content control apparatus and information about a first area that can be served by the at least one content control apparatus.

In an implementation manner of the present invention, referring to FIG. 7, the content control apparatus acquiring module 43 includes a first querying unit 431. The first querying unit 431 is configured to query stored registration information of the at least one content control apparatus according to the location information, where the registration information includes identifier information of the content control apparatus arid the information about the first area that can be served by the content control apparatus.

In another implementation manner of the present invention, referring to FIG. 3, the content control apparatus acquiring module 43 includes a second querying unit 432. The second querying unit 432 is configured to send a request for querying a content control apparatus to a domain name server DNS server or an application layer traffic optimization server ALTO server, where the query request carries the location information of access of the UE, so that the DNS server or the ALTO server queries stored registration information of the at least one content control apparatus according to the location information, and the registration information includes identifier information of the content control apparatus and the information about the first area that can be served by the content control apparatus.

That is, the content control apparatus may submit a registration request to the content delivery apparatus, the DNS server, or the ALTO server, where the registration request includes the information about the first area that can be served by the content control apparatus. The content delivery apparatus, the URS server, or the ALTO server configures, according to the submitted request, the identifier information of the corresponding content control apparatus and the information about the first area that can be served by the corresponding content control apparatus.

In another implementation manner, the content control apparatus may register with another control system such as an operation support system (OSS) or a business support system (BSS) of an NSP. Similarly, registration information includes identifier information of the content; control apparatus and information about an area that can be served by the content control apparatus. When the registration information of the content control apparatus needs to be acquired, the content delivery apparatus, the DNS server, or the ALTO server may send a query request to the OSS or the BSS, where the query request also carries the location information of access of the UE. The OSS or the BSS queries the stored registration information of the at least one content control apparatus according to the location information and returns the stored registration information to the content delivery apparatus, the DNS server, or the ALTO server.

It should be noted that the content control apparatus has a control logic function provided by the network service provider (NSP), that is, a mobile network operator, and is mainly configured to search for and select a cache device. The identifier information of the content control apparatus includes address information (an IP address or a URL address) of the content control apparatus, a fully qualified domain name (FQDN), or the like. The information about the first area that can be served by the content control apparatus includes a routing area (RA), a location area (LA), a tracking area (TA), or a cell (cell), or the like that can be served by the content control apparatus.

The content control apparatus determining module 44 is configured to determine, according to the location, information and the information about the first area, a content control apparatus for serving the UE.

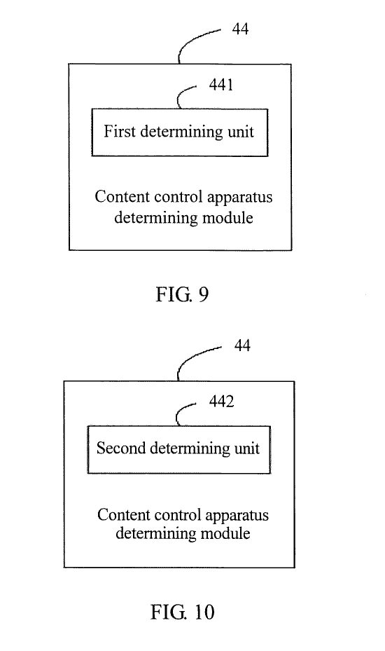

Referring to FIG. 9, in an embodiment of the present invention, the content control apparatus determining module 44 includes a first determining unit 441. The first determining unit 441 is configured to select one content control apparatus from the at least one content control apparatus according to the location information and the information about the first area, and determine the content control apparatus as the content control apparatus for serving the UE, which may be specifically: selecting, from the at least one content control apparatus, a content control apparatus whose service area is closest to the UE as the content control apparatus for serving the UE (that is, the information about the first area that can be served by the content control apparatus includes the location information of access of the UE). Further, identifier information of the determined content control apparatus is acquired.

Referring to FIG. 10, in another embodiment of the present invention, the content control apparatus determining module 44 includes a second determining unit 442. The second determining unit 442 is configured to: receive the registration information of the at least one content control apparatus returned by the DNS server or the ALTO server, select one content control apparatus from the at least one content control apparatus according to the location information and the information about the first area, and determine the content control apparatus as the content control apparatus for serving the UE. Further, receiving identifier information of the determined content control apparatus is included.

The search request sending module 45 is configured to send a request for searching for a cache device to the determined content control apparatus.

It should be noted that, the request for searching for a cache device is sent to the content control apparatus according to the identifier information of the content control apparatus, where the search request may carry identifier information of the content requested by the UE. In an implementation manner, the search request further carries the location information of access of the UE. The content control apparatus stores a correspondence between an identifier of a cache device and information about an area that can be served by the cache device. The content control apparatus can select, according to the location information of access of the UE and the correspondence, a cache device as a cache device that provides the requested content. Specifically, the content control apparatus may determine, according to the location information and the correspondence, a cache device closest to the UE as the cache device that provides the requested content for the UE, and deliver a flow rule to the determined cache device, where the flow rule carries the identifier information of the content requested by the UE, and the identifier is used to instruct the determined cache device to cache or submit the requested content when a content request that is of the UE and that is corresponding to the identifier is received.

In an implementation manner, if the content control apparatus determines multiple cache devices according to the location information of access of the UE, that is, information about areas that can be served by the multiple cache devices includes the location information of access of the UE. Further, it is queried whether the content corresponding to the identifier information of the content requested by the UE is cached in these cache, devices. If the content is cached in these cache devices, a cache device that caches the content requested by the UE is selected as a cache device that provides the requested content.

The identifier receiving module 46 is configured to receive an identifier of a cache device returned by the content control apparatus.

Specifically, an identifier of the cache device determined by the content control apparatus according to the location information of access of the UE is received.

The message sending module 47 is configured to send a redirection message to the UE, so that the UE redirects to the cache device corresponding to the identifier to acquire the requested content.

Specifically, the redirection message HTTP Redirect includes the identifier of the determined cache device. After receiving the redirection message, the UE re-sends a content request to the cache device according to identifier information of the cache device. The cache device acquires content according to an identifier that is of the requested content and carried in the content request, and sends the content to the UE. In this case, content submitting processing is completed.

In this embodiment of the present invention, a content delivery apparatus selects, according to an access location of UE, a content control apparatus to serve the UE; the selected content control apparatus reselects, for the UE, a cache device configured to provide requested content; and the UE can redirect to the cache device to acquire the requested content. Because the reselected cache device may be selected at a location close to the UE, a data interaction path between the UE and the cache device is shortened, which reduces transmission bandwidth of an operator network, thereby improving user experience. In addition, the content control apparatus for serving the UE is selected according to the access location of the UE, and in this way, the cache device selected by the selected content control apparatus belongs to an NSP accessed by a user, so that the selected cache device can provide a content service requested by the user. In addition, the content delivery apparatus controls whether to select a cache device of the network service provider to serve the UE, that is, a CP/SP controls whether to select a cache device of the NSP to serve the UE, thereby implementing layered control for a CDN. In addition, cache resources of the network service provider can be open to the content provider or the service provider, thereby implementing monetization processing of the cache resources and increasing income of the network service provider.

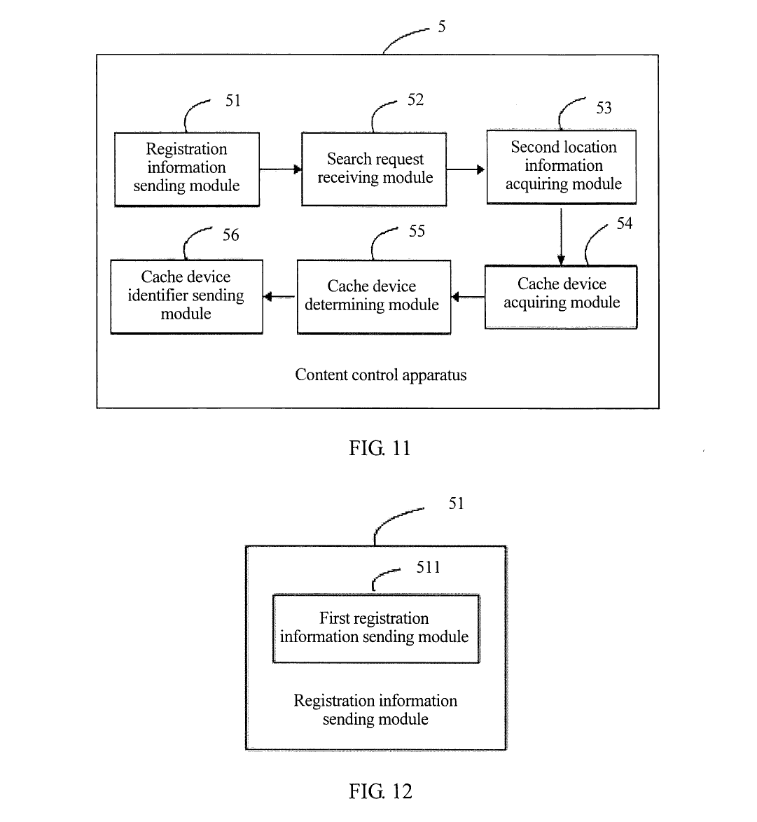

Referring to FIG. 11. FIG. 11 is a schematic structural diagram of a content control apparatus 5 according to an embodiment of the present invention. The content control apparatus 5 (that is, a downstream CDN) includes a registration information sending module 51, a search request receiving module 52, a second location information acquiring module 53, a cache device acquiring module 54, a cache device determining module 55, and a cache device identifier sending module 56.

In an implementation manner of the present invention, referring to FIG. 12, the registration information sending module 51 includes a first registration information sending module 511. The first registration information sending module 511 is configured to send registration information to a content delivery apparatus, where the registration information includes identifier information of the content control apparatus 5 and information about a first area that can be served by the content, control apparatus, so that the content delivery apparatus determines, according to location information of access of user equipment UE and the information about the first area, a content control apparatus for serving the UE.

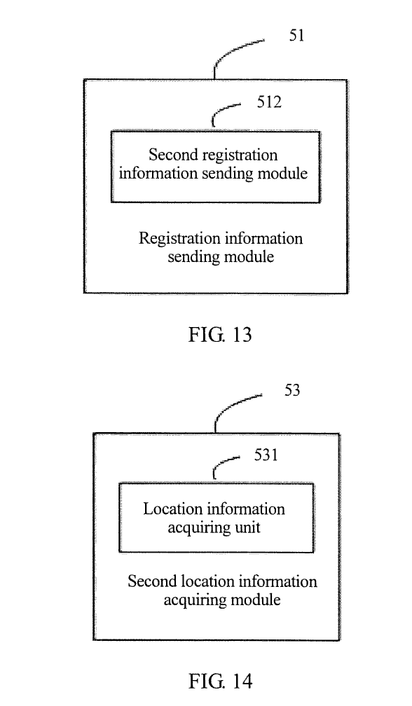

Alternatively, in another implementation manner of the present invention, referring to FIG. 13, the registration information sending module 51 includes a second registration information sending module 512. The second registration information sending module 512 is configured to send registration information to a domain name server DNS server or an application layer traffic optimization server ALTO server, where the registration information includes identifier information of the content control apparatus and information about a first area that can be served by the content control apparatus, so that the DNS server or the ALTO server determines, according to location information of access of user equipment UE and the information about the first area, a content control apparatus for serving the UE.

That is, the content control apparatus may submit a registration request to the content delivery apparatus, the DNS server, or the ALTO server, where the registration request includes the information about the first area that can be served by the content control apparatus. The content delivery apparatus, the DNS server, or the ALTO server configures, according to the submitted request, the identifier information of the corresponding content control apparatus and the information about the first area that can be served by the corresponding content control apparatus.

In another implementation manner, the content control apparatus may register with another control system such as an operation support system (OSS)or a business support system (BSS) of an NSP. Similarly, registration information includes identifier information of the content control apparatus and information about an area that can be served by the content control apparatus,

It should be noted that the content control apparatus has a control logic function provided by the network service provider (NSP), that is, a mobile network operator, and is mainly configured to search for and select a cache device. The identifier information of the content control apparatus includes address information (an IP address or a URL address) of the content control apparatus, a fully qualified domain name (FQDN), or the like. The information about the first area that can be served by the content control apparatus includes a routing area RA (Routing Area), a location area (LA), a tracking area (TA), a cell (cell), or the like that can be served by the content control apparatus.

The search request receiving module 52 is configured to receive a request for searching for a cache device sent by the content delivery apparatus, where the cache device is configured to provide content requested by the user equipment UE.

In some implementation manners of the present invention, if the first registration information sending module 511 registers with the content delivery apparatus, the content delivery apparatus may acquire the identifier information of the content control apparatus according to the registration information and send the search request to the search request receiving module 52.

In some implementation manners of the present invention, if the second registration information sending module 512 registers with the domain name server DNS server or the application layer traffic optimization server ALTO server, after acquiring the identifier information of the content control apparatus from the DNS server or the ALTO server according to the location information of access of the UE, the content delivery apparatus sends the search request to the search request receiving module 52.

In some implementation manners of the present invention, if the content control apparatus registers with the OSS or the BSS, after acquiring the registration information of the content control apparatus from the OSS or the BSS, the content delivery apparatus sends the search request to the content control apparatus; or the DNS server or the ALTO server acquires the registration information of the content control apparatus from the OSS or the BSS, and after the content delivery apparatus acquires the identifier information of the content control apparatus from the DNS server or the ALTO server according to the location information of access of the UE, the content delivery apparatus sends the search request to the search request sending module 52.

The second location information acquiring module 53 is configured to acquire the location information of access of the UE.

In some implementation manners of the present invention, if the search request carries the location information of access of the user equipment UE, that is, the content delivery apparatus directly provides the location information, of access of the. UE for the content control apparatus referring to FIG. 14, the second location information acquiring module 53 includes a location information acquiring unit 531, and the location information acquiring unit 531 is configured to parse the search request to acquire the location information of access of the user equipment UE.

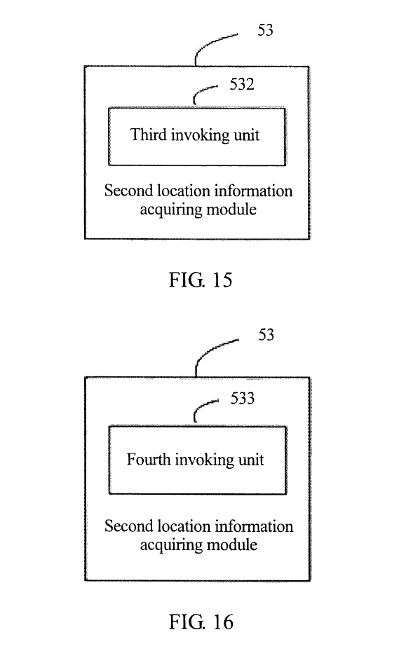

In some embodiments of the present invention, if the search request does not carry the location information of access of the user equipment UE, referring to FIG. 15, the second location information acquiring module 53 includes a third invoking unit 532, and the third invoking unit 532 is configured to invoke an application programming interface API provided by an open platform to acquire the location information of access of the UE. Alternatively, referring to FIG. 16, the second location information acquiring module 53 includes a fourth invoking unit: 533, and the fourth invoking unit 533 is configured to invoke an application programming interface API provided by the UE to acquire the location information of access of the UE.

The API is some predefined functions, and a purpose is to provide, for an application program and a developer, an ability to access a routine based on software or hardware without accessing source code or understanding details of an internal working mechanism,

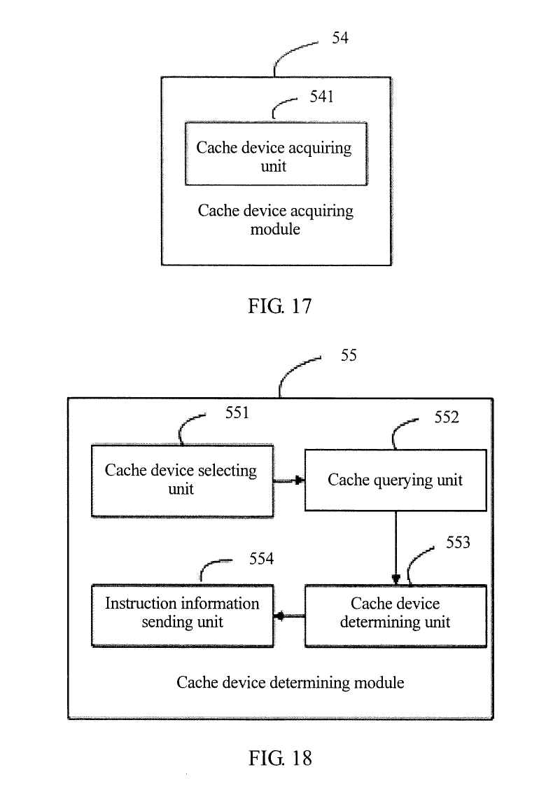

The cache device acquiring module 54 is configured to acquire at least one cache device and information about a second area that can be served by the at least one cache device. Specifically, referring to FIG. 17, the cache device acquiring module 54 includes a cache device acquiring unit 541, and the cache device acquiring unit 541 is configured to acquire at least one cache device of a network element of the network service provider NSP and information about a second area that can be served by the at least one cache device.

It should be noted that the content, control apparatus needs to acquire in advance and store a cache ability of each network element of the NSP, that is, information about a cache device that has a cache ability of a network element, such as an access network element (for example, a radio network controller (RNC), a base station controller (BSC), or an E-UTRAN NodeB (eNodeB), a gateway (for example, a gateway GPRS support node (GGSN) or a packet data network gateway (PDN GW), or a CDN, is sent to the content control apparatus,

The cache device determining module 55 is configured to determine a cache device for the UE according to the location information and the information about the second area, where the foregoing request for searching for a cache device includes an identifier information of the content requested by the UE. Referring to FIG. 18, the cache device determining module 55 includes a cache device selecting unit 551, a cache querying unit 552, a cache device determining unit 553, and an instruction, information sending unit 554.

The cache device selecting unit 551 is configured to select, according to the location information and the information about the second area, that can be served by the at least one cache device, a cache device from the at least one cache device as the cache device that provides the content requested by the UE.

It should be noted that cache devices of all network elements of the NSP may include a cache device of an access network, a cache device of a gateway, a cache device of a CDN, or the like, and each cache device has a cache ability to an extent. After acquiring cache ability information of a cache device, the content control apparatus selects, according to the location information of access of the UE and a correspondence between identifier information of a cache device and information about an area that can be served by the cache device, a cache device closest to the UE as the cache device for serving UE.

The cache querying unit 552 is configured to: when at least two cache devices are selected, query whether the content corresponding to the identifier information of the content requested by the UE is already cached in the selected cache devices.

The cache device determining unit 553 is configured to: select a cache device that caches the content requested, by the UE as the cache device that provides the content requested by the UE; and if none of the at least two selected cache devices caches the content, select, according to the location information, a cache device closest to the UE as the cache device that provides the content requested by the UE.

The instruction information sending unit 554 is configured to deliver instruction information to the determined cache device, where the instruction information carries the identifier information of the content requested by the UE, and the instruction information is used to instruct the cache device to store the requested content or submit the requested content to the UE when a content request corresponding to the identifier is received. After receiving the instruction information, if receiving the content request of the UE, the determined cache device accesses a corresponding site according to the identifier that is of the requested content and carried in the content request, and acquires and stores the requested content. Alternatively, if it is queried, according to the identifier that is of the requested content and carried in the content request, that the cache device has corresponding cache content, the cache content is submitted to the UE.

The cache device identifier sending module 56 is configured to send an identifier corresponding to the determined cache device to the content delivery apparatus, so that the content delivery apparatus sends a redirection message to the UE, and the UE redirects to the cache device corresponding to the identifier to acquire the requested content.

It should be noted that the identifier corresponding to the determined cache device includes URL information or URI information of the cache device. After the content delivery apparatus receives the URL information or the URI information of the cache device, the redirection message HTTP Redirect sent to the UE includes the URL information or the URI information of the cache device. The cache device acquires the content requested by the UE from a content provider CP or a service provider SP and stores the content requested by the UE. The UE may redirect to a cache device corresponding to the URL information or the URI information according to the URL information or the URI information of the cache device in the redirection message. In this case, content submitting processing is completed.

In this embodiment of the present invention, a content delivery apparatus selects, according to an access location of UE, a content control apparatus to serve the UE; the selected content control apparatus reselects, for the UE, a cache device configured to provide requested content; and the UE can redirect to the cache device to acquire the requested content. Because the reselected cache device may be selected at a location close to the UE, a data interaction path between the UE and the cache device is shortened, which reduces transmission bandwidth of an operator network, thereby improving user experience. In addition, the content control apparatus for serving the UE is selected according to the access location of the UE, and in this way, the cache device selected by the selected content control apparatus belongs to an NSP accessed by a user, so that the selected cache device can provide a content service requested by the user. In addition, the content delivery apparatus controls whether to select a cache device of the network service provider to serve the UE, that is, a CP/SP controls whether to select a cache device of the NSP to serve the UE, thereby implementing layered control for a CDN. In addition, cache resources of the network service provider can be open to the content provider or the service provider, thereby implementing monetization processing of the cache resources and increasing income of the network service provider.

An embodiment of the present invention provides a content delivery system, which includes the content delivery apparatus described in FIG. 4 to FIG. 10 and the content control apparatus described in FIG. 11 to FIG. 18. For a process of interaction between the content delivery apparatus and the content control apparatus, reference may be made to the foregoing embodiments, and details are not described herein again.

An embodiment of the present invention provides a computer storage medium, where the computer storage medium stores a first program, and the first program performs steps of the content delivery method shown in FIG. 1.

An embodiment of the present, invention further provides another computer storage medium, where the computer storage medium stores a second program, and the second program performs steps of the content delivery method shown in FIG. 2.

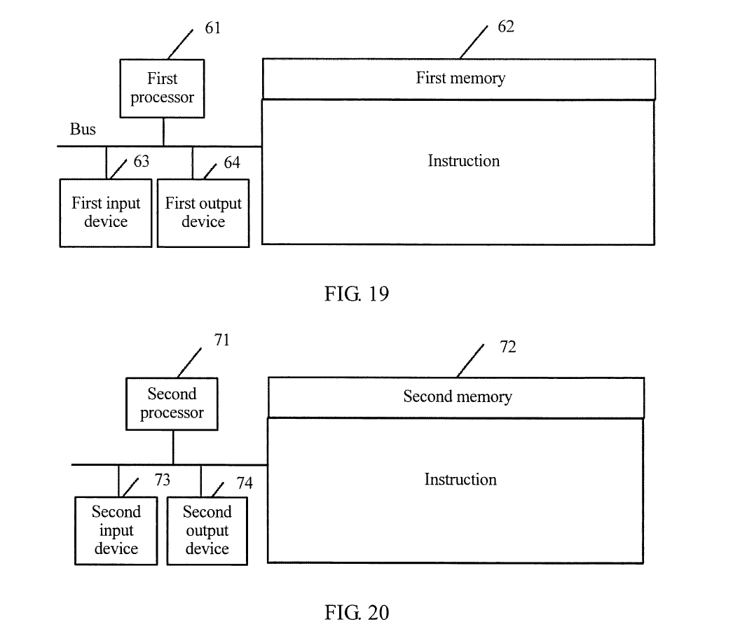

Referring to FIG. 19, an embodiment of the present invention further provides a content delivery apparatus, which includes a first processor 61 (a quantity of first processors 61 may be one or more, and one first, processor 61 is used as an example in FIG. 19), a first memory 62, a first input device 63, and a first output device 64. The first processor 61, the first memory 62, the first input device 63, and the first output, device 64 may be connected by using a bus or in another manner, where in FIG. 16, connecting by using a bus is used as an example. The first memory 62 stores a program to be executed by the processor 61.

The first processor 61 performs the following steps;

when, a content request of user equipment UE is received, acquire location information of access of the UE;

acquire at least one content control apparatus and information about a first area that can be served by the at least one content control apparatus;

determine, according to the location information and the information about the first area, a content control apparatus for serving the UE;

send a request for searching for a cache device to the determined content control apparatus;

receive an identifier of a cache device returned by the content control apparatus; and

send, a redirection message to the UE, so that the UE redirects to the cache device corresponding to the identifier to acquire requested content.

That the first processor 61 receives the content request of the user equipment UE includes:

controlling the first input device to receive a content request, of the user equipment UE forwarded by a content provider CP or a service provider SP.

In some embodiments of the present invention, that the first processor acquires the location information of access of the UE includes:

invoking an application programming interface API provided by an open platform to acquire the location information of access of the UE; or

invoking an application programming interface API provided by the UE to acquire the location information of access of the UE.

In some embodiments of the present invention, the acquiring at least one content control apparatus and information about a first area that can be served by the at least one content control apparatus includes:

querying stored registration information of the at least one content control apparatus according to the location information, where the registration information includes identifier information of the content control apparatus and the information about the first area chat can be served by the content control apparatus; and

the determining, according to the location information and the information about the first area, a content control apparatus for serving the UE includes:

selecting one content control apparatus from the at least one content control apparatus according to the location information and the information about the first area, and determining the content control apparatus as the content control apparatus for serving the UE.

In some embodiments of the present, invention, that the first processor acquires the at least one content control apparatus and the information about the first area that can be served by the at least one content control apparatus includes:

sending a request for querying a content control apparatus to a domain name server DNS server or an application layer traffic optimization server ALTO server, where the query request carries the location information of access of the UE, so that the DNS server or the ALTO server queries stored registration information of the at least one content control apparatus according to the location information, and the registration information includes identifier information of the content control apparatus and the information about the first area that can be served by the content control apparatus; and

the determining, according to the location information and the information, about the first area, a content control apparatus for serving the UE includes:

receiving the registration information of the at least one content control apparatus returned by the DNS server or the ALTO server, selecting one content control apparatus from the at least one content control apparatus according to the location information and the information about, the first area, and determining the content control apparatus as the content control apparatus for serving the UE.

In this embodiment of the present invention, a content delivery apparatus selects, according to an access location of UE, a content control apparatus to serve the UE; the selected content control apparatus reselects, for the UE, a cache device configured to provide requested content; and the UE can redirect to the cache device to acquire the requested content. Because the reselected cache device may be selected at a location close to the UE, a data interaction path between the UE and the cache device is shortened, which reduces transmission bandwidth of an operator network, thereby improving user experience. In addition, the content control apparatus for serving the UE is selected according to the access location of the UE, and in this way, the cache device selected by the selected content control apparatus belongs to an NSP accessed by a user, so that the selected cache device can provide a content service requested by the user. In addition, the content delivery apparatus controls whether to select a cache device of the network service provider to serve the UE, that is, a CP/SP controls whether to select a cache device of the NSP to serve the UE, thereby implementing layered control for a CDN. In addition, cache resources of the network service provider can be open to the content provider or the service provider, thereby implementing monetization processing of the cache resources and increasing income of the network service provider.

Referring to FIG. 20, an embodiment of the present invention further provides a content control apparatus, which includes a second processor 71 (a quantity of second processors 71 may he one or more, and one second processor 71 is used as an example in FIG. 20), a second memory 72, a second input device 73, and a second output device 74. The second processor 71, the second memory 72, the second input device 73, and the second output device 74 may be connected by using a bus or in another manner, where in FIG. 17, connecting by using a bus is used as an example. The second memory 72 stores a program to be executed by the second processor 71.

The second processor 71 performs the following steps:

receive a request for searching for a cache device sent by a content delivery apparatus, where the cache device is configured to provide content requested by user equipment UE;

acquire location information of access of the UE;

acquire at least one cache device and information about a second area that can be served by the at least one cache device;

determine a cache device for the UE according to the location information and the information about the second area; and

send an identifier corresponding to the determined cache device to the content delivery apparatus, so that the content delivery apparatus sends a redirection message to the UE, and the UE redirects to the cache device corresponding to the identifier to acquire the requested content.

The search request carries the location information of access of the user equipment UE; and

that the second processor acquires the location information of access of the UE includes:

parsing the search request to acquire the location information of access of the user equipment UE.

In some embodiments of the present invention, that the second processor acquires the location information of access of the UE includes:

invoking an application programming interface API provided by an open platform to acquire the location information of access of the UE; or

invoking an application programming interface API provided by the UE to acquire the location information of access of the UE.

In some embodiments of the present invention, before receiving the request for searching for a cache device of the content delivery apparatus, the second processor is further configured to:

send registration information to the content delivery apparatus, where the registration information includes identifier information of the content control apparatus and information about, a first area that can be served by the content control apparatus, so that the content delivery apparatus determines, according to the location information of access of the user equipment UE and the information about the first area, a content control apparatus for serving the UE; or

send registration information, to a domain name server DNS server or an application layer traffic optimization server ALTO server, where the registration information includes identifier information of the content control apparatus and information about a first area that can be served by the content control apparatus, so that the DNS server or the ALTO server determines, according to the location information of access of the user equipment UE and the information about the first area, a content control apparatus for serving the UE.

In some embodiments of the present invention, that the second processor acquires the at least one cache device and the information about the second area that can be served by the at least one cache device includes:

acquiring at least one cache device of a network element of a network service provider NSP and information about a second area that can be served by the at least one cache device.

In some embodiments of the present invention, the request for searching for a cache device includes an identifier information of the content requested by the UE; and

that the second processor determines the cache device for the UE according to the location information and the information about the second area includes:

selecting, according to the location information and the information about the second area that can be served by the at least one cache device, a cache device from the at least one cache device as the cache device that provides the content requested by the UE;

if at least two cache devices are selected, querying whether the content corresponding to the identifier information of the content requested by the UE is already cached in the selected cache devices; and

selecting, a cache device that caches the content requested by the UE as the cache device that provides the content requested by the UE.

In some embodiments of the present invention, that the second processor determines the cache device for the UE further includes:

delivering instruction information to the determined cache device, where the instruction information carries the identifier information of the content requested by the UE, and the instruction information is used to instruct the cache device to store the requested content or submit the requested content to the UE when a content request corresponding to the identifier is received.

In this embodiment of the present invention, a content delivery apparatus selects, according to an access location of us, a content control apparatus to serve the UE; the selected content control apparatus reselects, for the UE, a cache device configured to provide requested content; and the UE can redirect to the cache device to acquire the requested content. Because the reselected cache device may be selected at a location close to the UE, a data interaction path between the UE and the cache device is shortened, which reduces transmission bandwidth of an operator network, thereby improving user experience. In addition, the content control apparatus for serving the UE is selected according to the access location of the UE, and in this way, the cache device selected by the selected content control apparatus belongs, to an NSP accessed by a user, so that the selected cache device can provide a content service requested, by the user. In addition, the content delivery apparatus controls whether to select a cache device of the network service provider to serve the UE, that is, a CP/SP controls whether to select a cache device of the NSP to serve the UE, thereby implementing layered control for a CDN. In addition, cache resources of the network service provider can be open to the content provider or the service provider, thereby implementing monetization processing of the cache resources and increasing income of the network service provider.

With descriptions of the foregoing implementation manners, a person skilled in the art may clearly understand that the present invention may be implemented by hardware, firmware or a combination thereof. When the present invention is implemented by software, the foregoing functions may be stored in a computer-readable medium or transmitted as one or more instructions or code in the computer-readable medium. The computer-readable medium includes a computer storage medium and a communications medium, where the communications medium includes any medium that enables a computer program to be transmitted from one place to another. The storage medium may be any available medium accessible to a computer. The following provides an example but does not impose a limitation. The computer-readable medium may include a RAM, a ROM, an EEPROM, a CD-ROM, or another optical disc storage or disk storage medium, or another magnetic storage device, or any other medium that can carry or store expected program code in a form of an instruction or a data, structure and can be accessed by a computer. In addition, any connection may be appropriately defined as a computer-readable medium. For example, if software is transmitted from a website, a server or another remote source by using a coaxial cable, an optical fiber/cable, a twisted pair, a digital subscriber line (DSL) or wireless technologies such as infrared ray, radio and microwave, the coaxial cable, optical fiber/cable, twisted pair, DSL or wireless technologies such as infrared ray, radio and microwave are included in fixation of a medium to which they belong. For example, a disk (Disk) and disc (disc) used by the present invention includes a compact disc CD, a laser disc, an optical disc, a digital versatile disc (DVD), a floppy disk and a Blu-ray disc, where the disk generally copies data by a magnetic means, and the disc copies data optically by a laser means. The foregoing combination should also be included in the protection scope of the computer-readable medium.

What is disclosed above is merely embodiments of the present invention, and certainly is not intended to limit the protection scope of the present invention. Therefore, equivalent variations made in accordance with the claims of the present invention shall fall within the scope of the present invention.

What is claimed is:

1. A content delivery method, comprising:
when a content request of user equipment (UE) is received, acquiring location information of access of the UE;
acquiring at least one content control apparatus and information about a first area that can be served by the at least one content control apparatus;
determining, according to the location information and the information about the first area, a content control apparatus for serving the UE;
sending a request for searching for a cache device to the determined content control apparatus;
receiving an identifier of a cache device returned by the content control apparatus; and
sending a redirection message to the UE, so that the UE redirects to the cache device corresponding to the identifier to acquire requested content.

2. The content delivery method according to claim 1, wherein acquiring location information of access of the UE comprises:
invoking an application programming interface (API) provided by an open platform to acquire the location information of access of the UE; or
invoking an application programming interface (API) provided by the UE to acquire the location information of access of the UE.

3. The content delivery method according to claim 1, wherein:
acquiring at least one content control apparatus and information about a first area that can be served by the at least one content control apparatus comprises:
querying stored registration information of the at least one content control apparatus according to the location information, wherein the registration, information comprises identifier information of the content control apparatus and the information about the first area that can be served by the content control apparatus; and
determining, according to the location information and the information about the first area, a content control apparatus for serving the UE comprises:
selecting one content control apparatus from the at least one content control apparatus according to the location information and the information about the first area, and determining the content control apparatus as the content control apparatus for serving the UE.

4. The content delivery method according to claim 1, wherein:
acquiring at least one content control apparatus and information about a first area that can be served by the at least one content control apparatus comprises:
sending a request for querying a content control apparatus to a domain name server (DNS) server or an application layer traffic optimization server (ALTO) server, wherein the query request carries the location information of access of the UE, so that the DNS server or the ALTO server queries stored registration information of the at least one content control apparatus according to the location information, and the registration information comprises identifier information of the content control apparatus and the information about the first area that can be served by the content control apparatus; and
determining, according to the location information and the information about the first area, a content control apparatus for serving the UE comprises:
receiving the registration information of the at least one content control apparatus returned by the DNS server or the ALTO server, selecting one content control apparatus from the at least one content control apparatus according to the location information and the information about the first area, and determining the content control apparatus as the content control apparatus for serving the UE.

5. A content delivery method, comprising:
receiving a request for searching for a cache device sent by a content delivery apparatus;
acquiring location information of access of user equipment (UE);
acquiring at least one cache device and information about a second area that can be served by the at lease one cache device;
determining a cache device for the UE according to the location information and the information about the second area; and
sending an identifier corresponding to the determined cache device to the content delivery apparatus, so that the content delivery apparatus sends a redirection message to the UE, and the UE redirects to the cache device corresponding to the identifier to acquire requested content.

6. The content delivery method according to claim 5, wherein:
the search request carries the location information of access of the user equipment UE; and
acquiring location information of access of the UE comprises:
parsing the search request to acquire the location information of access of the user equipment UE.

7. The content delivery method according to claim 5, wherein acquiring location information of access of the UE comprises:
invoking an application programming interface (API) provided by an open platform to acquire the location information of access of the UE; or
invoking an application programming interface (API) provided by the UE to acquire the location information of access of the UE.

8. The content delivery method according to claim 5, before receiving a request for searching for a cache device sent by a content delivery apparatus, the method further comprises:
sending registration information, to the content delivery apparatus, wherein the registration information comprises identifier information of a content control apparatus and information about a first area that can be served by the content control apparatus, so that the content delivery apparatus determines, according to the location information of access of the user equipment UE and the information about the first area, a content control apparatus for serving the UE; or
sending registration information to a domain name server (DNS) server or an application layer traffic optimization server (ALTO) server, wherein the registration information comprises identifier information of the content control apparatus and information about a first area that can be served by the content control apparatus, so that the DNS server or the ALTO server determines, according to the location information of access of the user equipment UE and the information about the first area, a content control apparatus for serving the UE.

9. The content delivery method according to claim 5, wherein:
the request for searching for a cache device comprises an identifier information of the content requested by the UE; and
determining a cache device for the UE according to the location information and the information about the second area comprises:
selecting, according to the location information and the information about the second area that can be served by the at least one cache device, a cache device from the at least one cache device as the cache device that provides the content requested by the UE,
if at least two cache devices are selected, querying -whether the content corresponding to the identifier information of the content requested by the UE is already cached in the selected cache devices, and
selecting a cache device that caches the content requested by the UE as the cache device that provides the content requested by the UE.

10. The content delivery method according to claim 5, wherein determining a cache device for the UE further comprises:
delivering instruction information to the determined cache device, wherein the instruction information carries the identifier information of the content requested by the UE, and the instruction information is used to instruct the cache device, to score the requested content or submit the requested content to the UE when a content request corresponding to the identifier is received.

11. A content delivery apparatus, comprising:
a first memory, a first input device, and a first output device; and
a first processor configured to:
when a content request of user equipment (UE) is received, acquire location information of access of the UE,
acquire at least one content control apparatus and information about a first area that can be served by the at least one content control apparatus,
determine, according to the location information and the information about the first area, a content control apparatus for serving the UE,
send a request for searching for a cache device to the determined content control apparatus,
receive an identifier of a cache device returned by the content control apparatus, and
send a redirection message to the UE, so that the UE redirects to the cache device corresponding to the identifier to acquire requested content.

12. The content delivery apparatus according to claim 11, wherein the first processor is further configured to:
invoke an application programming interface (API) provided by an open platform to acquire the location information of access of the UE; or
invoke an application programming interface (API) provided by the UE to acquire the location information of access of the UE.

13. The content delivery apparatus according to claim 11, wherein the first processor is further configured to:
query stored registration information of the at least one content control apparatus according to the location information, wherein the registration information comprises identifier information of the content control apparatus and the information about the first area that can be served by the content control apparatus; and
select one content, control apparatus from the at least one content control apparatus according to the location information and the information about the first area, and determine the content control apparatus as the content control apparatus for serving the UE.

14. The content delivery apparatus according to claim 11, wherein the first processor is further configured to:
send a request for querying a content control apparatus to a domain name server (DNS) server or an application layer traffic optimization server (ALTO) server, wherein the query request carries the location information of access of the UE, so that the DNS server or the ALTO server queries stored registration information of the at least one content control apparatus according to the location information, and the registration information comprises identifier information of the content control apparatus and the information about the first area that can be served by the content control apparatus; and
receive the registration information of the at least one content control apparatus returned by the DNS server or the ALTO server, select one content control apparatus from the at least one content control apparatus according to the location information and the information about the first area, and determine the content control apparatus as the content control apparatus for serving the UE.

15. A content control apparatus, comprising:
a second memory, a second input device, and a second output device; and
a second processor configured to:
receive a request for searching for a cache device sent by a content delivery apparatus, wherein the cache device is configured to provide content requested by user equipment (UE),
acquire location information of access of the UE,
acquire at least one cache device and information about a second area that can be served by the at least one cache device,
determine a cache device for the UE according to the location information and the information about the second area, and
send an identifier corresponding to the determined cache device to the content delivery apparatus, so that the content delivery apparatus sends a redirection message to the UE, and the UE redirects to the cache device corresponding to the identifier to acquire the requested content.

16. The content control apparatus according to claim 15, wherein;
the search request carries the location information of access of the UE; and
the second processor is further configured to:
parse the search request to acquire the location information of access of the user equipment UE.

17. The content control apparatus according to claim 15, wherein the second processor is further configured to:
invoke an application programming interface (API) provided by an open platform to acquire the location information of access of the UE; or
invoke an application programming interface (API) provided by the UE to acquire the location information of access of the UE.

18. The content control apparatus according to claim 15, wherein before receiving the request for searching for a cache device of the content delivery apparatus, the second processor is further configured to:
send registration information to the content delivery apparatus, wherein the registration information comprises identifier information of the content control apparatus and information about a first area that can be served by the content control apparatus, so that the content delivery apparatus determines, according to the location information of access of the user equipment UE and the information about the first area, a content control apparatus for serving the UE; or
send registration information to a domain name server (DNS) server or an application layer traffic optimization server (ALTO) server, wherein the registration information comprises identifier information of the content control apparatus and information about a first area that can be served by the content control apparatus, so that the DNS server or the ALTO server determines, according to the location information of access of the user equipment UE and the information about the first area, a content control apparatus for serving the UE.

19. The content control apparatus according to claim 15, wherein:
the request for searching for a cache device comprises an identifier information of the content requested by the UE; and
the second processor is further configured to:
select, according to the location information and the information about the second area that can be served by the at least one cache device, a cache device from the at least one cache device as the cache device that provides the content requested by the UE,
if at least two cache devices are selected, query whether the content corresponding to the identifier information, of the content requested by the UE is already cached in the selected cache devices, and
select, a cache device that caches the content requested by the UE as the cache device that provides the content requested by the UE.

20. The content control apparatus according to claim 15, wherein the second processor is further configured to:
deliver instruction information to the determined cache device, wherein the instruction information carries the identifier information of the content requested by the UE, and the instruction information is used to instruct the cache device to store the requested content or submit the requested content to the UE when a content, request corresponding to the identifier is received.
